(19) United States
(12) Patent Application Publication
(10) Pub. No.: US 2025/0371600 A1
(43) Pub. Date: Dec. 4, 2025

(54) SYSTEMS AND METHODS FOR DETERMINING A DEAL STRUCTURE

(71) Applicant: Cox Automotive, Inc., Atlanta, GA (US)

(72) Inventors: Udit Luthur, Kennesaw, GA (US); Rahul Gupta, Cumming, GA (US)

(21) Appl. No.: 18/679,883

(22) Filed: May 31, 2024

(51) Int. Cl. G06Q 30/0601

(52) U.S. Cl. CPC G06Q 30/0631

(57) ABSTRACT

Methods for generating a deal structure is provided. A customer identifier associated with a customer interested in a vehicle is received. A financial data associated with the customer identifier and a vehicle data associated with the vehicle are determined. A plurality of recommended vehicles that are similar to the vehicle are determined based on the vehicle data associated with the vehicle. A deal structure metric is determined for each recommended vehicle of the plurality of recommended vehicles. At least one recommended vehicle is filtered from the plurality of recommended vehicles that based the deal structure metric. A vehicle recommendation to the customer is provided. The vehicle recommendation includes the vehicle information associated with the at least one recommended vehicle, one or more product or services associated with the at least one recommended vehicle, and the loan parameters associated with the at least one recommended vehicle.

### BACKGROUND

The vehicle purchasing process can be complex and overwhelming. Consumers who undertake the process first need to select a vehicle at a vehicle dealer from a vast pool of options. In addition, estimates for loan provided by many vehicle dealers are inaccurate as they are based on incomplete information. This makes the process of performing transaction more frustrating and inefficient for both the vehicle dealer and the customer.

Furthermore, vehicle transactions are often subject to a short transaction window. In other words, a dealer is more likely to retain a customer if the dealer is able to initiate a transaction, negotiate the terms of a transaction, and close the transaction in a shorter time window. Thus, in addition to the added frustration and inefficiency, the inability to rapidly and accurately provide data to a prospective customer may result in the dealer losing a vehicle sale.

### BRIEF DESCRIPTION OF THE DRAWINGS

The accompanying drawings, which are incorporated in and constitute a part of this disclosure, illustrate various implementations of the present disclosure. In the drawings:

FIG. 1 is a block diagram of an operating environment for determining a deal structure;

FIG. 2 is a block diagram of a vehicle transfer system for determining a deal structure;

FIG. 3 is a flow diagram of a method for determining a deal structure;

FIG. 4 is flow diagram of another method for determining a deal structure;

FIG. 5 is a flow diagram of a method for determining a deal structure metric; and

FIG. 6 is a block diagram of a computing device.

### DETAILED DESCRIPTION

The following disclosure provides many different implementations, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include implementations in which the first and second features are formed in direct contact, and may also include implementations in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various implementations and/or configurations discussed.

In accordance with example implementations, the disclosure provides methods and systems to generate a deal structure for purchase of a vehicle. The deal structure is generated to optimize or maximize a likelihood of acceptance by a customer, a likelihood of acceptance by a lending entity, and a profitability for a vehicle dealer. In one example, the profit may be increased by increasing an interest rate and including one or more product or services in the deal structure, such as warranties, maintenance plans, vehicle protection plans, and the like. However, by offering an increased interest rate and such product or services, a vehicle seller may risk losing the potential sale of a vehicle to a customer who may be unlikely to purchase the recommended products or services in addition to buying a vehicle. That is, the customer may not be interested in the vehicle products or services or may not be willing to spend more than a certain amount of money to purchase the products. Likewise, the vehicle dealer may increase profitability of vehicle sales by charging more interest and/or principal for a vehicle loan but may risk losing the vehicle sale by doing so.

The disclosed processes enable a vehicle dealer to increase their profit by providing a deal structure that has a greater chance of being accepted both by the customer and at least one lending entity. In addition to the vehicle under consideration, the disclosed processes provide alternative vehicle recommendations with corresponding deal structures to increase a likelihood of the customer making a purchase at the vehicle dealer. Furthermore, the disclosed processes provide such deal structures rapidly.

The disclosed processes. among other things, enhance a computer-based decision-making process traditionally performed by dealers (e.g., F&I managers or sale managers) to account for limited user input, likelihood of user purchasing a vehicle, and datasets that drive efficiency and profitability. For instance, given a limited user input (e.g., a user identifier). the disclosed processes may provide a deal structure based on various datasets that will most likely result in a user purchase. In addition, given a user identifier and a vehicle data, the disclosed processes may automatically and efficiently generate one or more deal structures for alternative vehicles that will be most likely result in a purchase, efficiently increasing dealer profit, and improving overall customer experience.

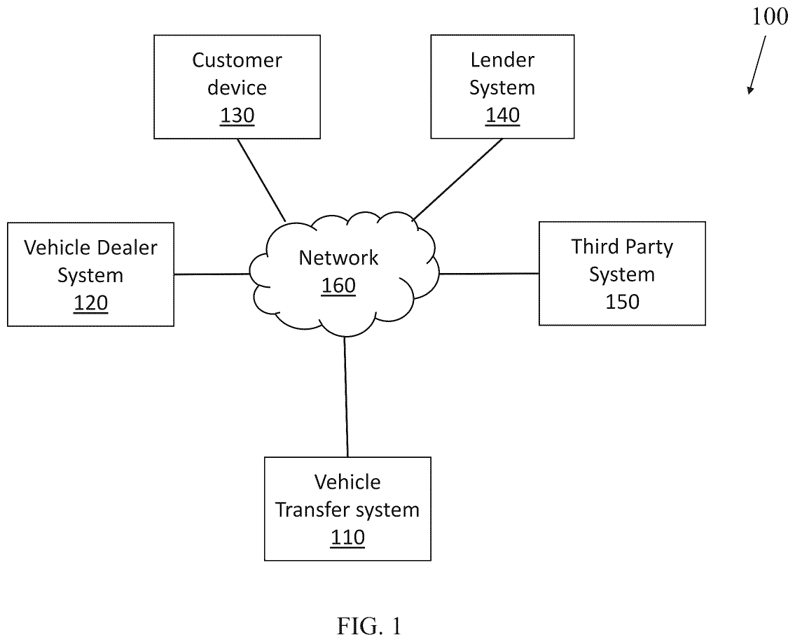

FIG. 1 illustrates an example operating environment 100 for generating a vehicle deal structure in accordance with example implementations of the disclosure. As shown in FIG. 1, operating environment 100 may include a vehicle transfer system 110, a vehicle dealer system 120, a customer device 130, a lender system 140, and a third party system 150. Operating environment 100 may include multiple instances of one or more of these devices and systems 120 through 150. In addition, operating environment 100 may include additional components that are not shown in FIG. 1.

Operating environment 100 further includes a network 160 through which systems and devices 110 through 150 may communicate with each other. Network 160 may include any combination of local and/or wide area networks, using both wired and/or wireless communication systems. For example, network 160 includes communication links using technologies such as Ethernet, 802.11, Worldwide Interoperability for Microwave Access (WiMAX), 3G, 4G, 5G, 6G, 7G, Code Division Multiple Access (CDMA), Digital Subscriber Line (DSL), etc. Examples of networking protocols used for communicating via network 160 include Multiprotocol Label Switching (MPLS), Transmission Control Protocol/Internet Protocol (TCP/IP), Hypertext Transport Protocol (HTTP), Simple Mail Transfer Protocol (SMTP), and File Transfer Protocol (FTP). Data exchanged over network 160 may be represented using any suitable format, such as Hypertext Markup Language (HTML) or Extensible Markup Language (XML).

Vehicle transfer system 110 interacts with some or all of the other systems and devices 120 through 150 to perform a vehicle transfer transaction. Vehicle transfer transaction may refer to sale or lease of a vehicle from a vehicle dealer to a customer (e.g., potential buyer) of the vehicle dealer. Vehicle transfer system 110 may further communicate with some or all of the other systems and devices 120 through 150 to secure one or more forms of financing for the vehicle transfer transaction. More particularly, and as discussed in greater detail in following sections of the disclosure, vehicle transfer system 110 may generate a deal structure for a vehicle a customer is interested in as well as providing alternative vehicle recommendations with corresponding deal structures.

Vehicle dealer system 120 is a computing system operated by a vehicle dealer that provides information about the vehicle dealer, such as contact information for the vehicle dealer, information about one or more vehicles in the possession of the vehicle dealer, lending entities associated with the vehicle dealer, etc. In one implementation, vehicle dealer system 120 is a web server that provides a publicly available website operated by the vehicle dealer. As referred to herein, a vehicle dealer is an entity that possesses or otherwise has the right to sell, lease, rent, or temporarily transfer control of a vehicle to another entity (e.g., a customer). A vehicle dealer may be a licensed vehicle dealership or vehicle manufacturer (e.g., a business entity) or a solo independent being (e.g., a human entity) that interfaces with vehicle transfer system 110 for transferring control of a vehicle to facilitate a vehicle transfer transaction.

Customer device 130 is a computing device operated by a customer to view the information provided by dealer system 120. Customer device 130 may be a computing device that belongs to the customer, such as a personal laptop computer, desktop computer, tablet computer, or smartphone. Customer device 130 may alternatively be a computing device that a vehicle dealer provides for a customer to use. For example, customer device 130 may be a computing device that is physically located inside a vehicle dealership in a manner that is accessible to customers, which allows a customer to view the information provided by vehicle dealer system 120 during an in-person visit to the vehicle dealer. As referred to herein, a customer is a person or entity that seeks to possess or otherwise buy, lease, rent, or otherwise at least temporarily obtain control of a vehicle from another entity (e.g., a vehicle dealer). A customer may include a licensed vehicle dealership (e.g., a business entity) or a solo independent being (e.g., a person) that may interface with vehicle transfer system 110 for obtaining control of a vehicle to facilitate a vehicle transfer transaction.

Lender system 140 is operated by a lending entity, a bank, or other capital source that seeks to make funds available in a loan to another entity (e.g., to a customer for use in at least temporarily obtaining control of a vehicle from a vehicle dealer) with the expectation that the element of value will be repaid (e.g., within a certain amount of time, in addition to any interest and/or fees, either in increments or as a lump sum). Such a lending entity may be a licensed public or private group or a financial institution (e.g., a business entity or collection of individuals) or a solo independent being (e.g., a human entity) that may interface with vehicle transfer system 110 for making a loan to a customer to facilitate a vehicle transfer transaction.

Third party system 150 provides a third party application or service that processes or provides any suitable subject matter that may be used by any other system or device in operating environment 100 to enable a vehicle transfer transaction. In one implementation, third party system 150 is operated by a financial institution (e.g., banks) that provides financial information or credit scores for any suitable users or vehicles of the platform. For example, third party system 150 may be operated by an information management service and credit information service, such as TransUnion of Chicago, Ill., Equifax Inc. of Atlanta, Ga., Experian PLC of Dublin, Republic of Ireland, Edmunds.com, Inc. of Santa Monica, Calif., Black Book auto valuation of Heart Business Media Corporation of New York, N.Y., Kelley Blue Book auto valuation of Cox Automotive of Atlanta, Ga., Plaid Technologies, Inc. of San Francisco, Calif., Twilio of San Francisco, Calif., and the like, from which data may be collected by any suitable data hub or Data Management System (“DMS”) and shared with vehicle transfer system 110. Third party system 150 may also include historical loan application data providers (for example, DealerTrack).

As other examples, third party system 150 may be operated by a risk management research entity, an ancillary goods/services provisioning entity, an entity that may provide Vehicle Service Contract (VSC) products and/or F&I products, backup and recovery provider entities, an underwriter, a loan servicer, a financial transaction electronic network, electronic signature facilitator entities, a loan agent, an investor, a social network that provides any suitable connection information between various parties, a government agency/regulator, a licensing body, a third party advertiser, an owner of relevant data, a seller of relevant goods/materials, a software provider, a maintenance service provider, or a scheduling service provider.

Although operating environment 100 and systems and devices 110 through 150 are described herein with respect to the transfer of a vehicle from a vehicle dealer to a customer, operating environment 100 can alternatively be used to transfer a different type of good or service (e.g., a real estate property, business supply, etc.) according to one or more of the concepts described in this disclosure.

As referred to herein, a vehicle dealer or a dealership is an entity that possesses or otherwise has the right to sell, lease, rent, or temporarily transfer control of a vehicle to another entity (e.g., a customer). A vehicle dealer may be a licensed vehicle dealership or vehicle manufacturer (e.g., a business entity) or a solo independent being (e.g., a human entity) that interfaces with vehicle transfer system 110 for transferring control of a vehicle to facilitate a vehicle transfer transaction.

In example implementations, vehicle transfer system 110, may include multiple machine learning models. Using these machine learning models, vehicle transfer system 110 may generate a deal structure for a vehicle that the customer has indicated an interest in or recommend alternate vehicles that are similar to the vehicle that the customer has indicated an interest in, and may recommend deal structures for those recommended vehicles. Vehicle transfer system 110 may identify the factors that are most likely to cause a purchase to occur or not occur. For example, vehicle transfer system 110 may determine that a location of the customer (e.g., associated with a type of driving, weather, etc.), the financial information of a customer (e.g., what the customer may afford to purchase/borrow), and the like may be strong causal factors in the decision to purchase a vehicle and a related product or service. The type of product or service may be causally related to the type or price of a vehicle, for example. In this manner, vehicle transfer system 110 may evaluate a corpus of data that includes information about one or more users in one or more geographic areas, information about vehicles, information about vehicle purchases and loans, information about lenders, and the like to structure a deal (for example, loan terms) for a vehicle under consideration or identify alternative vehicles to present to a prospective vehicle buyer (that is, a customer) based on whether the recommendations are both profitable and are likely to result in a purchase. For example, vehicle transfer system 110 may determine that a customer is likely to purchase a vehicle with a vehicle product or service at a monthly payment or interest rate up to a threshold amount, but likely to reject a deal when offered a monthly payment or interest rate that exceeds that threshold amount. Accordingly, vehicle transfer system 110 may determine a deal structure with loan terms based on a likelihood that a customer will purchase a vehicle according to the loan terms (e.g., based on any combination of information for the customer, the vehicle, lenders, etc.) that will also be likely to be approved by one or more lenders.

More particularly, in some implementations, vehicle transfer system 110 may receive a customer identifier (e.g., a user identification number, a social security number, driver license number, etc.). Vehicle transfer system 110 may determine financial data (e.g., a credit score, purchase history, etc.) associated with the user/customer identifier, and vehicle data associated with a vehicle (e.g., a vehicle that the customer has indicated an interest in). Vehicle transfer system 110 may determine a product or service associated with the vehicle (e.g., a service contract, product warranty, etc.) to recommend to the customer (e.g., a recommended product or service to increase the profitability of the purchase of the vehicle, but that also satisfies criteria indicating that the customer is likely to purchase the recommended product or service with the vehicle).

Vehicle transfer system 110 may determine loan parameters for the vehicle based on the vehicle data and the customer information. That is, vehicle transfer system 110, based on a value of the vehicle and one or more product or services determine an amount of loan, and based on the amount of the loan and the financial data associated with the customer. Vehicle transfer system 110 may determine associated loan terms for a loan from one or more lending entities for the purchase of the vehicle and the one or more product or services. That is, vehicle transfer system 110 may determine loan information associated with the customer identifier and the vehicle (e.g., loan terms according to which the customer may purchase a vehicle and related product or service). The loan information may include an interest rate, price of the vehicle, monthly payment details, a payment term (e.g., number of months), one or more credit limits, a loan-to-value ratio, and/or any suitable information associated with loans for a customer with the customer identifier.

Vehicle transfer system 110 may determine whether one or more lending entities will approve the loan terms for purchase of the vehicle based on the financial data associated with the customer identifier and the vehicle data. For example, vehicle transfer system 110 may determine, using machine learning models, a first value indicative of a probability of approval of the loan terms from at least one lending entity. Moreover, vehicle transfer system 110 may determine, using machine learning models, a second value indicative of a probability that the customer will purchase the vehicle and the product or service based on the loan terms (e.g., whether the user will accept offered loan terms for a particular purchase). Furthermore, vehicle transfer system 110 may determine, a third value indicative of a profitability of a purchase of the vehicle and the product or service based on the loan terms (e.g., a higher profitability with a higher interest rate, but possibly a lower probability of purchase with a higher interest rate). Vehicle transfer system 110 may create a deal structure metric that includes the vehicle, the one or more product or services associated with the vehicle, the loan terms, the first value indicative of a probability of approval of the loan terms from at least one lending entity, the second value indicative of a probability that the customer will purchase the vehicle and the product or service based on the loan terms, and the third value indicative of the profitability of the purchase of the vehicle and the product or service based on the loan terms.

Vehicle transfer system 110 may create a deal structure for purchase of the vehicle under consideration based on the deal structure matrix. For example, vehicle transfer system 110 may create a deal structure where a product of the first value indicating acceptance by the user, the second value indicating acceptance by at least one lender, and the third value indicating profitability is optimized. Vehicle transfer system 110 may determine that any recommended vehicle product or service for a purchase of a vehicle not only increases the profitability of a sale enough to recommend the product or service, but also does not render the possible purchase too unlikely or render acceptance of the loan approval from a lender too unlikely. Similarly, vehicle transfer system 110 may determine a higher profitability with a higher interest rate, but possibly a lower probability of purchase with a higher interest rate. Therefore, creating a deal structure where a product of the first value indicating acceptance by the user, the second value indicating acceptance by at least one lender, and the third value indicating profitability is maximized may provide a better position for the vehicle dealer.

In some implementations, vehicle transfer system 110 may identify alternate vehicles that are similar to the vehicle under consideration. These alternate vehicles may be identified based on the vehicle data associated with the vehicle under consideration. Some of these alternate vehicles may be more affordable from the vehicle under consideration. Vehicle transfer system 110 can also determine a deal structure for these alternate vehicles.

Once vehicle transfer system 110 generates the deal structure for the vehicle under consideration and alternate vehicles, it may send the deal structure with the loan information to a user device for presentation (e.g., concurrent presentation of the loan information along with recommended products and/or services and/or the vehicle, or a presentation of the loan information associated with the vehicle and/or other suitable vehicles). In example implementations, vehicle transfer system 110 may allow the user to adjust the financial data (e.g., increasing or decreasing a down payment, or the like) of the deal structure. Vehicle transfer system 110, based on the adjustment of the financial data by the user, provide, at or near real-time, an updated presentation of the deal structure. When accepted by the customer, vehicle transfer system 110 may route the loan application to one or more lenders for financing. As discussed in greater detail in the following sections of the disclosure, in some implementations, vehicle transfer system 110 may select one or more lenders based on the probability of acceptance of the loan application and a profitability.

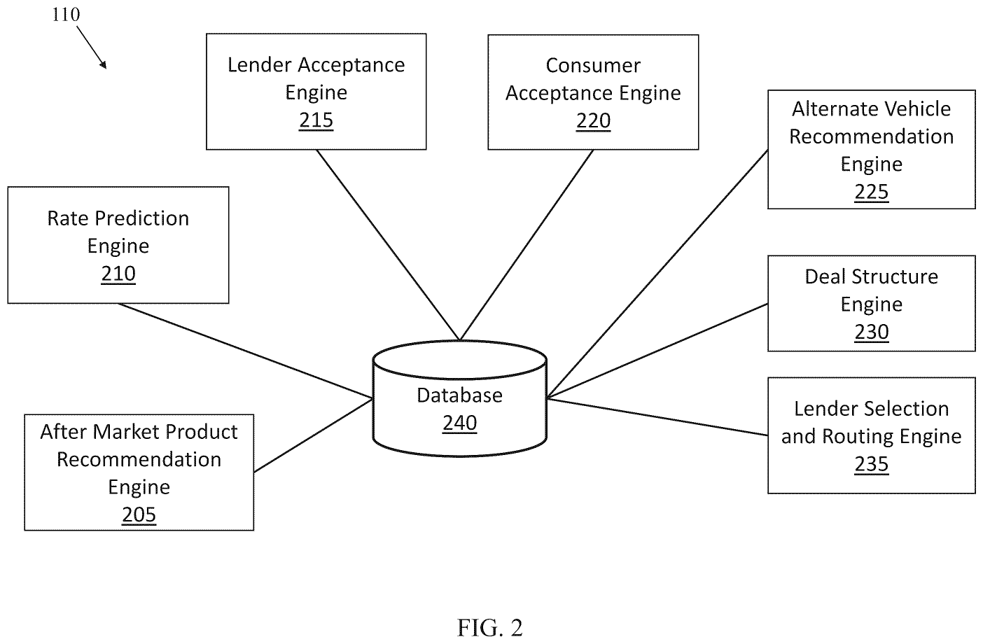

FIG. 2 illustrates vehicle transfer system 110 in accordance with example implementations of the disclosure. As shown in FIG. 2, vehicle transfer system 110 includes an after market product recommendation engine 205, a rate prediction engine 210, a lender acceptance engine 215, a consumer acceptance engine 220, an alternate vehicle recommendation engine 225, a deal structure engine 230, and a lender selection and routing engine 235. Vehicle transfer system 110 may further include a database 240. Database 240 stores historical data regarding vehicles purchase and lease. The historical data may include, for example, loan application data comprising a list of approved/disapproved loan applications, a buy lending rate for each of accepted loan applications, a sale lending rate for each of the accepted loan applications, a customer profile or customer variables associated with each approved/disapproved loan application, a vehicle data or vehicle variables associated with each approve/disapproved loan application, and financial data or loan parameters associated with each of approved/disapproved loan applications. Accepted loan applications may include loan applications which resulted in financing of a vehicle transfer transaction. The historical data can be collected from a plurality of lending entities or from third party system 150 that collects historical loan application approval data. In example implementations, database 240 may be representative of multiple datasets at multiple locations provided/maintained by different entities. For example, each of after market product recommendation engine 205, rate prediction engine 210, lender acceptance engine 215, consumer acceptance engine 220, alternate vehicle recommendation engine 225, deal structure engine 230, and lender selection and routing engine 235 may be interact with their own associated datasets or with different third party datasets.

After market product recommendation engine 205 may determine, using machine learning models, a likelihood of user purchasing a product or service based on various datasets, and may recommend a product or service that will most likely result in a user purchase. The machine learning models may evaluate a corpus of data that includes information about one or more users in one or more geographic areas, information about vehicles, information about vehicle purchases and loans, information about lenders, and the like to identify recommended vehicle products and services to present to a prospective vehicle buyer based on whether the recommendations are both profitable and are likely to result in a purchase. For example, the machine learning models may determine that a customer is likely to purchase a vehicle with a vehicle product or service at a monthly payment or interest rate up to a threshold amount, but likely to reject a deal when offered a monthly payment or interest rate that exceeds that threshold amount. In addition, the machine learning models may determine that a lender is likely to approve a deal structure for purchase of the vehicle with a vehicle product or service up to a threshold amount, but likely to reject the deal that exceeds that threshold amount. Thus, after market product recommendation engine 205 may determine a product or service associated with the vehicle (e.g., a service contract, product warranty, etc.) to recommend to the customer (e.g., a recommended product or service to increase the profitability of the purchase of the vehicle, but that also satisfies criteria indicating that the customer is likely to purchase the recommended product or service with the vehicle). After market product recommendation engine 205 may determine that any recommended vehicle product or service for a purchase of a vehicle not only increases the profitability of a sale enough to recommend the product or service, but also does not render the possible purchase too unlikely.

Rate prediction engine 210 may determine or predict loan terms including a lending rate for financing a purchase of a vehicle that the customer has indicated an interest in and one or more product or services recommended by after market product recommendation engine 205. In one implementation, rate prediction engine 210 may include a first machine learning model and a second machine learning model. The second machine learning model, once trained, may predict a buy lending rate for financing the purchase from the one or more lending entities based on the customer profile, the vehicle data, and the loan parameters. The second machine learning model, once trained, may predict a sale lending rate for financing the purchase based on the buy lending rate determined or predicted by the first machine learning model. A difference between the sale lending rate and the buy lending rate may reflect profitability.

The first machine learning model, once trained, determines the buy lending rate based on the customer profile, the deal variables, and the loan parameters. The first machine learning model is trained on the historical loan approval data including a list of accepted loan applications, the buy lending rate for each of accepted loan applications, and the customer profiles, vehicle variables, and the loan variables for each of the accepted loan applications. The first learning model may include a learning algorithm, for example, a gradient boosting algorithm. During the learning or the training phase, the first machine learning model builds models sequentially to reduce errors of a previous model in predictions of the buy lending rate. The new models in the sequence are built based on the errors or residuals of the previous models. After being trained on the historical loan approval data, the first machine learning model may determine the buy lending rate for financing the purchase of the vehicle by the customer based on the customer information and the vehicle information.

The second machine learning model, once trained, determines or predicts the sale lending rate based on the buy lending rate predicted by the first machine learning model. The second machine learning model is also trained based on the historical loan approval data including a list of accepted loan applications, the buy lending rate for each of accepted loan applications, and the sale lending rate for each of the accepted loan applications. The second machine learning model includes a learning algorithm, for example, an nth degree polynomial. In some examples, the learning algorithm includes a seventh-degree polynomial. During the learning or training process, the second machine learning model uses the buy lending rate and the sale lending rate from the accepted loan applications to determine coefficients of the polynomial. After being trained on the historical loan application approval data, the second machine learning model predicts the sale lending rate for financing purchase of the vehicle and one or more product or services recommended for the vehicle based on the buy lending rate predicted by the first machine learning model.

In some implementations, rate prediction engine 210 may determine a threshold interest rate based on the historical data including previous purchases by the same customer for similar vehicles, previous purchases by similar customers for the same vehicle, and/or previous purchases by similar customers for similar vehicles. The threshold interest rate may be an interest rate above which a customer is unlikely to purchase a vehicle (e.g., the probability of the purchase using an interest rate above the threshold interest rate may fail to exceed a probability of purchase threshold), and below which the probability of purchase may satisfy a probability of purchase threshold.

When rate prediction engine 210 determines that interest rates are strong factors in determining the probability of purchase, rate prediction engine 210 may determine an interest rate to offer to a customer based on the rate for which the customer is approved and the likelihood that the customer will purchase the vehicle at the selected interest rate. For example, similar vehicles may have features that are similar to and/or the same as some or all of vehicle data of a vehicle that a customer is interested in. Features may include a make, a model, a year, a price, a vehicle type, tire type, size, colors, sunroofs, extended cabs, four-wheel drive, number of engine cylinders, deals, features associated with the deals, local market information, geological location of dealers selling the vehicle, one or more dealer goals, inventory cost, customer incentives, dealer rebates, trade-in valuation, aftermarket products, dealer pay plans, cost of dealer-trade, floor-planning, or aged inventory. Similar customers may include customers who have financial, demographic, and/or geographic information that are similar and/or the same as some or all of data of a customer whose vehicle purchase is being evaluated by the computer system. Financial information may include address information (e.g., current and past home addresses), employment information (e.g., current and past employers, etc.), account information (e.g., credit cards, installment loans, mortgages or auto loans, etc.), public records (e.g., bankruptcies), and/or user characteristics (e.g., behavioral driving habit, a residency, age, gender, etc.). The computer system may determine loan information associated with the similar vehicles and/or similar customers.

In some implementations, rate prediction engine 210 may determine a threshold interest rate based on previous purchases by the same customer for similar vehicles, previous purchases by similar customers for the same vehicle, and/or previous purchases by similar customers for similar vehicles. The threshold interest rate may be an interest rate above which a customer is unlikely to purchase a vehicle (e.g., the probability of the purchase using an interest rate above the threshold interest rate may fail to exceed a probability of purchase threshold), and below which the probability of purchase may satisfy a probability of purchase threshold.

Lender acceptance engine 215 determines a probability of a deal structure being accepted by at least one lending entity. Lender acceptance engine 215 receives or determines the customer information and the vehicle data. Lender acceptance engine 215 may determine the customer information based on the customer identifier. Lender acceptance engine 215 may determine the customer information from vehicle dealer system 120 or third party system 150. The customer information may include one or more of personal information (e.g., birth date, current and past home addresses, phone numbers, and/or current and past employers, etc.), customer's current income, credit scores, account information (e.g., credit cards, installment loans, mortgages or auto loans, etc.), public records (e.g., bankruptcies), and/or user characteristics (e.g., behavioral driving habit, a residency, age, gender, etc.).

Moreover, lender acceptance engine 215 may determine or receive vehicle data associated with the vehicle under consideration or to be transferred to the customer. Vehicle data may include a book value or a sale price of the vehicle from vehicle dealer system 120. In addition, the vehicle data may include customer incentives, a dealer rebates trade-in valuation, aftermarket products, dealer pay plans, cost of dealer trade, etc. Moreover, the vehicle data may further include local market information, geological location of the dealer, dealer goals, etc. Furthermore, the vehicle data can include one or more features, such as, a make, a model, a year, a vehicle type, a tire type, size, color, number of engine cylinders, etc. In some examples, the vehicle data is also referred to as vehicle variables.

In addition, lender acceptance engine 215 may determine loan parameters or loan parameters associated with the loan application for financing the transfer of the vehicle to the customer. The loan parameters may include an amount of credit or funds the customer is seeking in the loan application from a lending entity, an amount of down payment the customer is willing to provide, a length of the loan (i.e., a loan term), a Loan to Value (LTV) ratio for the vehicle, lending entities parameters, etc. Lender acceptance engine 215 then determines a first value indicative of a probability of acceptance of the loan parameters for financing the transfer of the vehicle by at least one of a plurality of lending entities based on the customer information or customer profile. For example, a third machine learning model of lender acceptance engine 215, once trained, predicts the first value indicative of the probability of acceptance of the loan parameters. In some examples, the plurality of lending entities may include each lending entity a vehicle dealer works with or has ties with.

The third machine learning module of lender acceptance engine 215 is trained based on the historical loan approval/disapproval data. The third machine learning model, like the first machine learning model of rate prediction engine 210, may include a learning algorithm, for example, a gradient boosting algorithm. During the training or the learning phase, the third machine learning model may build models sequentially to reduce errors in predictions of a previous model. The new models in the sequence are built based on the errors or residuals of the previous models. In some examples, the first learning module includes a tree-based classification algorithm. For example, during a learning or a training phase, the first learning module makes initial set of trees for each inputs and provides or predicts a binary decision as an output for each inputs. In one implementation, a tree based on the credit score may use the credit score as input and is trained to provide an output as yes when the credit score is greater than 700 and if not then provide an output as no. The third machine learning model compares the predicted outcomes from the initial set of trees with historical outcomes and determines an error in prediction from the initial set of trees. The third machine learning model then creates a next set of trees based on the errors in the previous set of trees to reduce the errors in predictions from the previous round. This process of creating new set of trees to reduce the errors in predications in the previous set of trees can be repeated for a number of rounds or when the errors are less than a predetermined level. The administrator can set the number of rounds form the error reduction (for example, 10,000 rounds).

As described above, the third machine learning model of lender acceptance engine 215 is trained based on the historical data. For example, database 240 may include historical loan application approval/disapproval data from the current dealership, from other dealerships in a same geographical area as the current dealership, and from other dealerships in other geographical areas or from all over the country. Database 240 may acquire and retain the historical loan application approval data for a predetermined length of time (for example, 6, month, 1 year, 5 years, etc.) and can constantly update based on new approvals. The historical loan application approval data can include the consumer variables, the deal variables, and the consumer variables for each of approved/disapproved loan applications. After being trained on the historical loan application approval data, the first learning module may predict or determine a first value that is indicative of the probability of acceptance of the deal structure based on the customer profile and the deal variables by at least one of the plurality of lending entities.

Consumer acceptance engine 220 may determine, using machine learning models, a second value indicative of a probability that the customer will accept the loan parameters determined by rate prediction engine 210. That is, consumer acceptance engine 220 may determine the second value indicative of the probability that the customer will purchase the vehicle and the product or service based on the upfront payment and the interest rate determined by rate prediction engine 210 or proposed in the deal structure. In some implementations, a first deal structure may be more likely to be accepted by a customer than a second deal structure. For example, a lower monthly payment over a longer payment term as specified in the deal structure may be more or less likely to be accepted than a higher monthly payment over a shorter payment term. Consumer acceptance engine 220 may determine that the customer is likely or unlikely to accept any deal structure before offering a loan to a customer, and may use machine learning to identify the factors that most strongly correlate to the probability that a customer may purchase a vehicle and the product or service. Based on the factors that most strongly correlate to the probability that a customer may purchase a vehicle, consumer acceptance engine 220 may determine the second value indicative of the probability that the customer will accept the loan parameters determined by rate prediction engine 210 or proposed in a deal structure.

Alternate vehicle recommendation engine 225 may determine, using machine learning models, two or more alternate vehicles that are similar to the vehicle that a customer is interested in. For example, alternate vehicles may have features that are similar to and/or the same as some or all of vehicle data of the vehicle that the customer is interested in. Features may include a make, a model, a year, a price, a vehicle type, tire type, size, colors, sunroofs, extended cabs, four-wheel drive, number of engine cylinders, deals, features associated with the deals, local market information, geological location of dealers selling the vehicle, one or more dealer goals, inventory cost, customer incentives, dealer rebates, trade-in valuation, aftermarket products, dealer pay plans, cost of dealer-trade, floor-planning, or aged inventory. Alternate vehicle recommendation engine 225 may determine loan parameters for each of the alternate vehicles and filter one or more alternate vehicles to recommend to the customer.

Alternate vehicle recommendation engine 225 may recommend similar vehicles and loan information that may result in an acceptable profit and that the customer is most likely to purchase. In some implementations. alternate vehicle recommendation engine 225 may select and recommend the most profitable vehicles (e.g., the three most profitable vehicles based on respective loan information for the vehicles). Alternate vehicle recommendation engine 225 may rank the respective values associated with the three or more vehicles. A value at the first place of the ranking may indicate that a customer is most likely to accept loan information that is also most likely resulting in the highest profit than values at the second place and third place. Alternate vehicle recommendation engine 225 may send the indications of the loan information associated with vehicles having the values at the top three places to the user device for presentation.

Deal structure engine 230, using machine learning models, may create a deal structure for financing the purchase of a vehicle and the one or more product or services associated with the vehicle. In one example, the deal structure is created based on a deal structure metric which include the customer information, the vehicle data, the loan parameters, the first value indicative of a probability of acceptance of the loan parameters by at least one lending entity, a second value indicative of a probability of the customer purchasing the vehicle and the one or more product or service based on the loan parameters, and a third value indicative of a profitability in the purchase of the vehicle and the one or more products or services based on the loan parameters. The deal structure engine 230 may generate a deal structure where a product of the first value, the second value, and the third value is optimized. In some deal structures a product of the first value, the second value, and the third value is maximized. The first value, the second value, and the third value are interrelated and changing one effects the other. For example, increasing profitability may reduce both the probability of acceptance of the loan parameters by a lending entity and the probability of the customer purchasing the vehicle. In one implementation, a higher interest rate may result in a vehicle purchase being more profitable, but may result in the vehicle purchase being less likely. Alternatively, a lower interest rate may result in the vehicle purchase being most likely, but may result in the vehicle purchase being less profitable.

Lender selection and routing engine 235, using machine learning models, may determine a lender to route the loan application for financing the purchase of the vehicle and the one or more product or services selected by the customer. The lender is predicted to maximize both a probability or likelihood of acceptance of the loan parameters by the lender and a profit for the vehicle dealer. For example, the machine learning models of lender selection and routing engine 235 may determine a lending entity that provides a best profit margin for the vehicle dealer and route the loan application to that lending entity. The machine learning models of lender selection and routing engine 235 are trained based on the historical data.

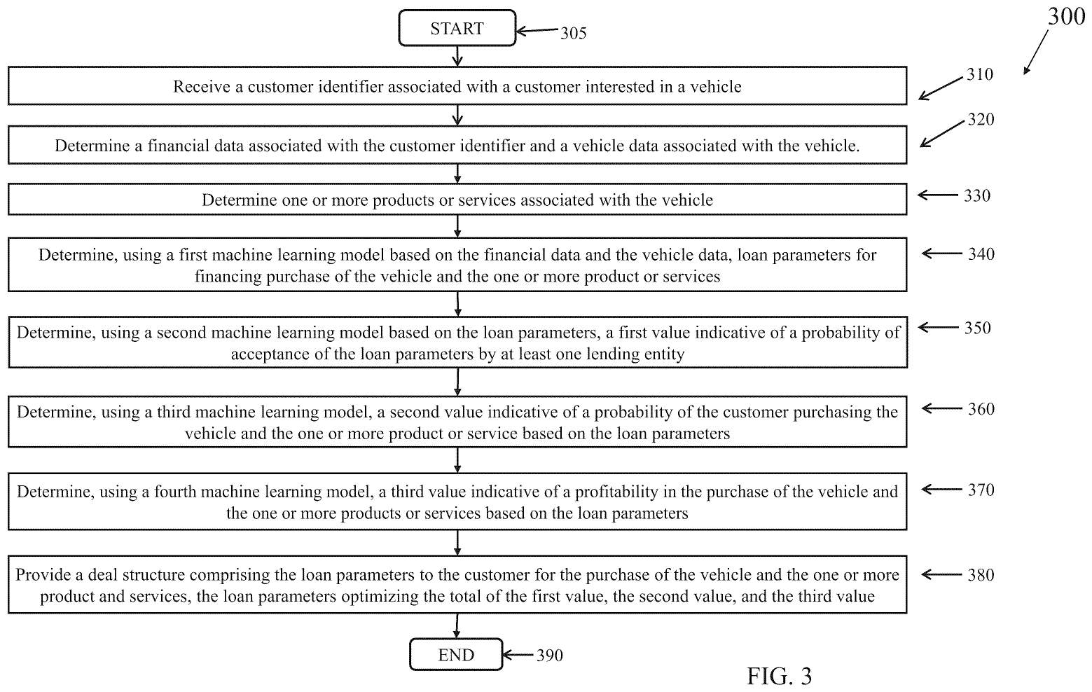

FIG. 3 is a flow chart setting forth the general stages involved in a method 300 consistent with an implementation of the disclosure for providing a deal structure for hat the customer has indicated an interest in. Steps of method 300 may be performed by a device comprising a processor, for example, vehicle transfer system 110 of operating environment 100 as described in more detail above with respect to FIGS. 1 and 2. Ways to implement the stages of method 300 will be described in greater detail below.

Method 300 begins at starting block 305 and proceeds to stage 310 where vehicle transfer system 110 may receive a customer identifier associated with a customer interested in a vehicle. For example, a customer may show an initial interest by selecting a vehicle to learn more about. The customer can select the vehicle either when surfing through an online listing of vehicles or by physically walking at a vehicle lot of the vehicle dealer. After showing the initial interest, the customer may be prompted to provide the customer identifier either to an administrator at the vehicle dealer or by filing an online form through customer device 130. The customer may provide the customer identifier. The customer identifier can include a user identification number, a social security number, a driver license number, first/last name, a phone number, etc. In some examples, vehicle transfer system 110 may provide a Graphical User Interface (GUI) to the customer or the administrator to provide or input the customer identifier.

After receiving the customer identifier at stage 310, method 300 may proceed to stage 320 where vehicle transfer system 110 may determine a financial data associated with the customer identifier and a vehicle data associated with the vehicle. Vehicle transfer system 110 may determine the financial data and the vehicle data from vehicle dealer system 120 or third party system 150.

The financial data may describe financial information associated with the customer identifier. Financial information may include personal information (e.g., birth date, current and past home addresses, phone numbers, and/or current and past employers, etc.), account information (e.g., credit cards, installment loans, mortgages or auto loans, etc.), public records (e.g., bankruptcies), and/or user characteristics (e.g., behavioral driving habit, a residency, age, gender, etc.). The financial data may include one or more datasets associated with one or more financial information. For example, the financial data may include a dataset associated with personal information, a dataset associated with account information, a dataset associated with user characteristics, and so forth.

The vehicle data may describe vehicle information associated with a vehicle. as a sale price of the vehicle from vehicle dealer system 120. In addition, the vehicle data can include customer incentives, a dealer rebates trade-in valuation, aftermarket products, dealer pay plans, cost of dealer trade, etc. Moreover, the vehicle data can further include local market information, geological location of the dealer, dealer goals, etc. Furthermore, the vehicle data can include one or more features, such as, a make, a model, a year, a vehicle type, a tire type, size, color, number of engine cylinders, etc. the vehicle data is also referred to as vehicle variables. That is, the vehicle data may include one or more features (e.g., a make, a model, a year, a vehicle type, tire type, size, colors, sunroofs, extended cabs, four-wheel drive, number of engine cylinders, etc.), deals, features associated with the deals (e.g., deal type, expiration date, etc.), products or services (e.g., vehicles alone, product or services for vehicle protection, vehicle accessories, extended warranties, insurance, paint protections, etc.), local market information, geological location of dealers selling the vehicle, one or more dealer goals (e.g., increasing back-end gross profit, increasing profitability, etc.), inventory cost, customer incentives, dealer rebates, trade-in valuation, aftermarket products, dealer pay plans, cost of dealer-trade, floor-planning, or aged inventory. The vehicle data may include one or more datasets associated with one or more vehicle information. For example, the vehicle data may include a dataset associated with the features, a dataset associated with deals, a dataset associated with products or services, and so forth.

Once having determined the financial data associated with the customer identifier and the vehicle data associated with the vehicle at stage 320, method 300 proceeds to stage 330 where vehicle transfer system 110 may determine one or more products or services associated with the recommended vehicle. The product or service may include product or services for vehicle protection, vehicle accessories, extended warranties, insurance, paint protections, or any suitable product or service associated with a vehicle. Vehicle transfer system 110 may determine the product or service based on the vehicle data and/or financial data. For example, vehicle transfer system 110 may determine that a vehicle may have deals for vehicle accessories (e.g., mud flaps or the like) based on the vehicle data including deals and features associated with the deals. Vehicle transfer system 110 may recommend mud flaps to the customer. In another example, a machine learning model may result in a determination that buyers of higher priced vehicles are likely to purchase a service contract, or that buyers in areas with significant winter weather may be more likely to purchase a vehicle warranty or four-wheel drive packages. In some examples, vehicle transfer system 110 may determine multiple products or services associated with a vehicle to a customer. In some implementations, vehicle transfer system 110 may recommend the most profitable products or services that a customer will be most likely to purchase to the customer. Vehicle transfer system 110 may determine a product or service associated with the vehicle (e.g., a service contract, product warranty, etc.) to recommend to the customer (e.g., a recommended product or service to increase the profitability of the purchase of the vehicle, but that also satisfies criteria indicating that the customer is likely to purchase the recommended product or service with the vehicle).

After determining the one or more products or services associated with the vehicle at stage 330, method 300 proceeds to stage 340 where vehicle transfer system 110 may determine, using a first learning model based on the financial data associated with the customer identifier and the vehicle data associated with the vehicle, loan parameters for financing purchase of the vehicle and the one or more product or services. The loan parameters can include an interest rate, price of the vehicle, monthly payment details, a payment term (e.g., number of months), one or more credit limits, a loan-to-value ratio, and/or any suitable information associated with loans for a customer with the customer identifier. As discussed above, vehicle transfer system 110 may determine loan parameters based on loan information that was considered for other similar vehicles and/or for similar customers.

Once having determined loan parameters for financing purchase of the vehicle and the one or more product or services at stage 340, method 300 may proceed to stage 350 where vehicle transfer system 110 may determine, using a second learning model based on the loan parameters, a first value indicative of a probability of acceptance of a loan application with the loan parameters by at least one lending entity. As discussed above the first value indicative of the probability of acceptance of the loan application is determined based on historical data of loan applications accepted by one or more lending entities.

After determining the first value indicative of the probability of acceptance of the loan application by the at least one lending entity at stage 350, method 300 proceeds to stage 360 where vehicle transfer system 110 may determine a second value indicative of a probability that the customer will purchase the vehicle and the product or service based on the associated loan parameters. As discussed above, the second value indicative of a probability that the customer will purchase the vehicle and the product or service may be determined based on whether or not that loan information associated with similar vehicles have been accepted by the same customer and/or similar customers (e.g., purchases of similar vehicles by the same customer and/or similar customers, absence of purchases of similar vehicles by the same customer and/or similar customers). In some examples, vehicle transfer system 110 may determine a threshold value or range (e.g., a threshold interest rate, a threshold interest rate range, or the like) for determining the second value, the threshold value of range indicating whether or not loan information (e.g., interest rate, payment term, or the like) will be accepted by a customer. If the loan parameters are less than or equal to the threshold value, vehicle transfer system 110 determine that a customer is most likely to accept the loan information. For example, an interest rate is less than or equal to a threshold interest rate. Vehicle transfer system 110 may determine that a customer is most likely to accept the interest rate. As another example, an interest rate is greater than the threshold interest rate, vehicle transfer system 110 may determine that a customer is less likely to accept the interest rate.

Once having determined the second value indicative of a probability of the customer purchasing the vehicle and the one or more product or services based on the loan parameters at stage 360, method 300 proceeds to stage 370 where vehicle transfer system 110 may determine, using a fourth machine learning model, a third value indicative of a profitability of the purchase of the vehicle and the one or more products or services based on the associated loan parameters. The profitability increases with higher interest rate and more product and services being included in the deal.

After determining the third value indicative of a profitability on the purchase of the vehicle and the one or more products or services at stage 370, method 300 may proceed to stage 380 where vehicle transfer system 110 may provide a deal structure comprising the loan parameters to the customer for the purchase of the vehicle and the one or more product or services, the proposed loan parameters maximizing the total of the first value, the second value, and the third value. The deal structure may further include an interest rate, price of the vehicle, monthly payments, a payment term, one or more credit limits, a loan-to-value ratio, and/or any suitable information associated with vehicle loans for a customer. After providing the deal structure to the customer at stage 380, method 300 may stop at end block 390.

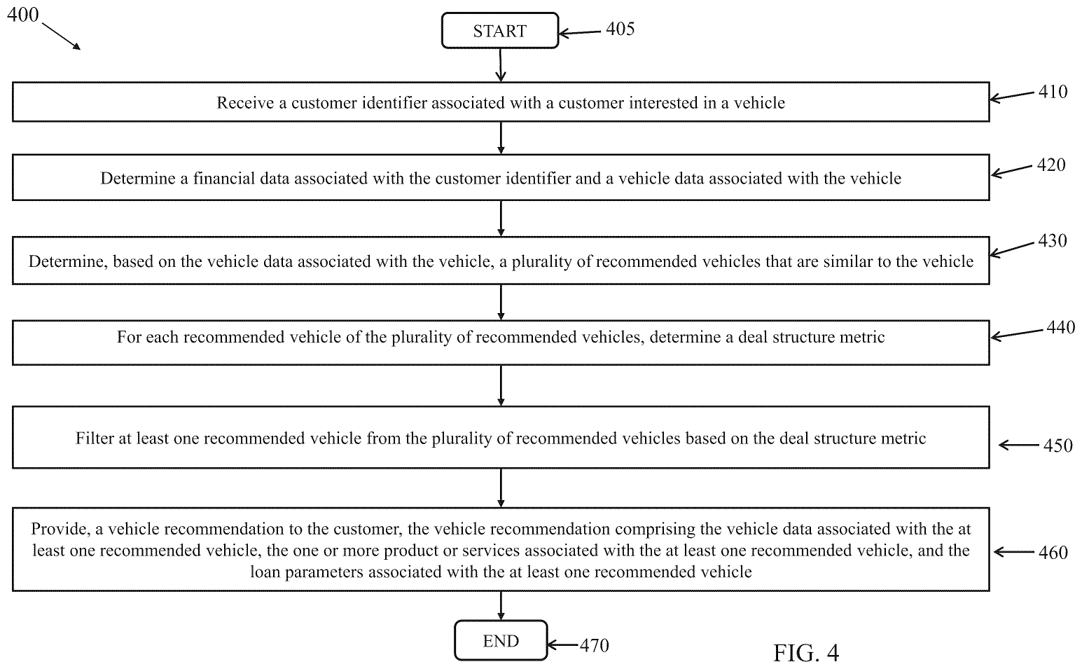

FIG. 4 is a flow chart setting forth the general stages involved in a method 400 consistent with an implementation of the disclosure for providing a deal structure for hat the customer has indicated an interest in. Steps of method 400 may be performed by a device comprising a processor, for example, vehicle transfer system 110 of operating environment 100 as described in more detail above with respect to FIGS. 1 and 2. Ways to implement the stages of method 400 will be described in greater detail below.

Method 400 begins at starting block 405 and proceeds to stage 410 where vehicle transfer system 110 may receive a customer identifier associated with a customer interested in a vehicle. As discussed above, vehicle transfer system may receive the customer identifier from the customer, vehicle dealer system 120, or from third-party system 150.

After receiving the customer identifier at stage 410, method 300 proceeds to stage 420 where vehicle transfer system 110 may determine a financial data associated with the customer identifier and a vehicle data associated with the vehicle. Vehicle transfer system 110 may determine the financial data and the vehicle data from vehicle dealer system 120 or third party system 150.

Once having determined the financial data associated with the customer identifier and the vehicle data associated with the vehicle at stage 420, method 400 proceeds to stage 430 where vehicle transfer system 110 may determine, based on the vehicle data associated with the vehicle, a plurality of recommended vehicles that are similar to the vehicle. The recommended vehicles may include vehicles that are similar to the vehicle the customer is interested in. In some examples, the recommended vehicles include vehicles that are more affordable than the vehicle the customer is interested in. As discussed above, the similar vehicles are determined based on the vehicle data of the vehicle the customer is interested in.

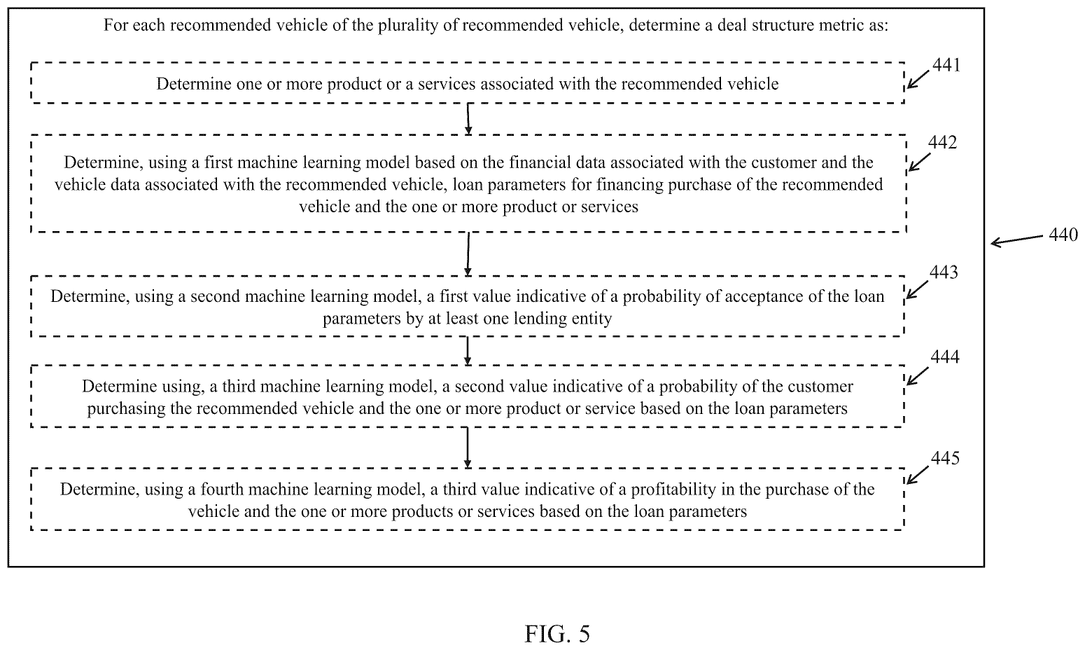

After determining the plurality of recommended vehicles that are similar to the vehicle at stage 430, method 400 proceeds to stage 440 where vehicle transfer system 110 may, for each recommended vehicle of the plurality of recommended vehicles determine a deal structure metric. FIG. 5 illustrates stages of a process/method of determining the deal structure metric. For example, and as shown in FIG. 5, at stage 441, vehicle transfer system 110 may determine one or more product or services associated with the recommended vehicle. As discussed above, the one or more product or services are determined based on the customer information and the vehicle data. At stage 442, vehicle transfer system 110 may determine, using a first learning model based on the financial data associated with the customer identifier and the vehicle data associated with the recommended vehicle, loan parameters for financing purchase of the recommended vehicle and the one or more product or services associated with the recommended vehicle.

At stage 443, vehicle transfer system 110 may determine, using a second machine learning model, a first value indicative of a probability of acceptance of the loan parameters by at least one lending entity. At stage 444, vehicle transfer system 110 may determine, using a third machine learning model, a second value indicative of a profitability of the customer purchasing the recommended vehicle and the one or more product or services based on the loan parameters. At stage 445, vehicle transfer system 110 may determine, using a fourth machine learning model, a third value indicative of a profitability in the purchase of the vehicle and the one or more products or services based on the loan parameters.

Referring back to FIG, 4, once having determined the deal structure metric for each of the plurality of recommended vehicles at stage 440, method 400 proceeds to stage 450 where vehicle transfer system 110 may filter at least one recommended vehicle from the plurality of recommended vehicles based on a maximum of a combination of each of the first value, the second value, and the third value.

After filtering the at least one recommended vehicle from the plurality of recommended vehicles at stage 450, method 400 proceeds to stage 460 where vehicle transfer system 110 may provide a vehicle recommendation to the customer. The vehicle recommendation includes the vehicle data associated with the at least one recommended vehicle, the one or more product or services associated with the at least one recommended vehicle, and the loan information associated with the at least one recommended vehicle.

The processes disclosed herein provide a number of technical effects and benefits. As one example of a technical effect and benefit, the processes of the disclosure may use a trained machine learning model to determine loan parameters and deal structures to account for a likelihood of a user purchasing the product or service, and/or a likelihood of achieving one or more dealer goals (e.g., increasing back-end gross profit, increasing front-end gross profit, etc.). In addition, human bias is removed and customer experience is improved. Such processes provide a robust machine learning model that efficiently improves dealership profitability regardless of complexity of dealer goals.

As another example technical effect and benefit, the processes may use the robust machine learning model to automatically and efficiently recommend alternate vehicles and products or services while limiting user inputs, instead of requiring users to bring many personal documents and to complete redundant documents, and without requiring multiple parties and computers to determine and provide recommendations. As yet another example technical effect and benefit, the processes of the disclosure may use the trained machine learning model for product or service recommendation, instead of using a “middle man” such as dealers, F&I managers, and sale mangers. As such, processing time may be significantly reduced from more than one hours to several seconds.

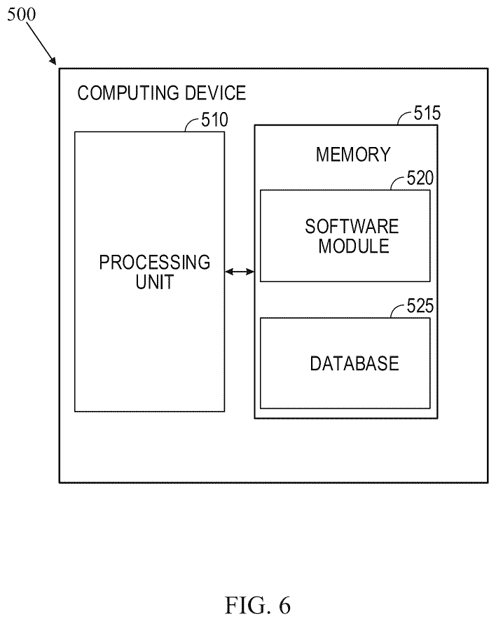

FIG. 6 shows computing device 500. As shown in FIG. 6, computing device 500 includes a processing unit 510 and a memory unit 515. Memory unit 515 includes a software module 520 and a database 525. While executing on processing unit 510, software module 520 performs, for example, processes for providing a deal structure, including for example, any one or more of the stages from methods 300 and 400 described above with respect to FIG. 3 and FIG. 4. Computing device 500, for example, provides an operating environment vehicle transfer system 110, vehicle dealer system 120, customer device 130, lender system 140, and third party system 150. Vehicle transfer system 110, vehicle dealer system 120, customer device 130, lender system 140, and third party system 150 may operate in other environments and are not limited to computing device 500.

Computing device 500 can be implemented using a tablet device, a mobile device, a smart phone, a telephone, a remote control device, a personal computer, a network computer, a mainframe, a router, a switch, a server cluster, a smart TV-like device, a network storage device, a network relay device, or other similar microcomputer-based device. Computing device 500 can include any computer operating environment, such as hand-held devices, multiprocessor systems, microprocessor-based or programmable sender electronic devices, minicomputers, mainframe computers, and the like. Computing device 500 can also be practiced in distributed computing environments where tasks are performed by remote processing devices. The aforementioned systems and devices are examples and computing device 500 can comprise other systems or devices.

Implementations of the disclosure, for example, can be implemented as a computer process (method), a computing system, or as an article of manufacture, such as a computer program product or computer readable media. The computer program product can be a computer storage media readable by a computer system and encoding a computer program of instructions for executing a computer process. The computer program product can also be a propagated signal on a carrier readable by a computing system and encoding a computer program of instructions for executing a computer process. Accordingly, the present disclosure can be embodied in hardware and/or in software (including firmware, resident software, micro-code, etc.). In other words, implementations of the present disclosure can take the form of a computer program product on a computer-usable or computer-readable storage medium having computer-usable or computer-readable program code embodied in the medium for use by or in connection with an instruction execution system. A computer-usable or computer-readable medium can be any medium that can contain, store, communicate, propagate, or transport the program for use by or in connection with the instruction execution system, apparatus, or device.

The computer-usable or computer-readable medium can be, for example but not limited to, an electronic, magnetic, optical, electromagnetic, infrared, or semiconductor system, apparatus, device, or propagation medium. More specific computer-readable medium examples (a non-exhaustive list), the computer-readable medium can include the following: an electrical connection having one or more wires, a portable computer diskette, a Random Access Memory (RAM), a Read-Only Memory (ROM), an Erasable Programmable Read-Only Memory (EPROM or Flash memory), an optical fiber, a portable Compact Disc Read-Only Memory (CD-ROM), and a portable pen drive. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain implementations of the disclosure have been described, other implementations may exist. Furthermore, although implementations of the present disclosure have been described as being associated with data stored in memory and other storage mediums, data can also be stored on or read from other types of computer-readable media, such as secondary storage devices, like hard disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, implementations of the disclosure may be practiced in an electrical circuit comprising discrete electronic elements, packaged or integrated electronic chips containing logic gates, a circuit utilizing a microprocessor, or on a single chip containing electronic elements or microprocessors. Implementations of the disclosure may also be practiced using other technologies capable of performing logical operations such as, for example, AND, OR, and NOT, including but not limited to, mechanical, optical, fluidic, and quantum technologies. In addition, implementations of the disclosure may be practiced within a general purpose computer or in any other circuits or systems.

Implementations of the disclosure may be practiced via a system-on-a-chip (SOC) where each or many of the element illustrated in FIGS. 1 and 2 may be integrated onto a single integrated circuit. Such a SOC device may include one or more processing units, graphics units, communications units, system virtualization units and various application functionality all of which may be integrated (or “burned”) onto the chip substrate as a single integrated circuit. When operating via a SOC, the functionality described herein with respect to implementations of the disclosure, may be performed via application-specific logic integrated with other components of computing device 500 on the single integrated circuit (chip).

Implementations of the present disclosure, for example, are described above with reference to block diagrams and/or operational illustrations of methods, systems, and computer program products according to implementations of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for implementations of the disclosure.

What is claimed:

1. A method comprising:
receiving, by a device comprising a processor, a customer identifier associated with a customer interested in a vehicle;
determining, by the device, a financial data associated with the customer identifier and a vehicle data associated with the vehicle;
determining, by the device, one or more product or services associated with the vehicle;
determining, by the device using a first machine learning model based on the financial data associated with the customer identifier and the vehicle data associated with the vehicle, loan parameters for financing purchase of the vehicle;
determining, by the device using a second machine learning model based on the loan parameters, a first value indicative of a probability of acceptance of the loan parameters by at least one lending entity;
determining, by the device using a third machine learning model, a second value indicative of a probability of the customer purchasing the vehicle and the one or more product or services based on the loan parameters;
determining, by the device using a fourth machine learning model, a third value indicative of a profitability in the purchase of the vehicle and the one or more products or services based on the associated loan parameters;
providing, by the device, a deal structure comprising the loan parameters to the customer for the purchase of the vehicle and the one or more product or services, the loan parameters optimizing the total of the first value, the second value, and the third value.

2. The method of claim 1, wherein determining the loan parameters comprises:
identifying, by the device, one or more estimates associated with a value of the vehicle and the one or more product or services; and
determining, by the device, based on the one or more estimates, the loan parameters.

3. The method of claim 1, wherein determining the loan parameters comprises:
determining, by the device, a buy lending rate; and
determining, by the device, a sale lending rate based on the buy lending rate.

4. The method of claim 3, further comprising:
determining, the profitability as a difference between the sale lending rate and the buy lending rate.

5. The method of claim 3, further comprising:
training the first machine learning model based on historical loan application approval data to predict the buy lending, the historical loan application approval data comprising a list of accepted loan applications, a buy lending rate for each of the accepted loan applications, the customer profile for each of the accepted loan applications, and the financial data for each of the accepted loan applications.

6. The method of claim 3, further comprising:
training the first machine learning model based on historical loan application approval data and the buy lending rate to predict the sale lending rate, the historical loan application approval data comprising a list of accepted loan applications, the buy lending rate for each of the accepted loan applications, and the sale lending rate for each of the accepted loan applications.

7. The method of claim 1, further comprising:
training the second machine learning model based on historical loan application approval data to determine the first value indicative of the probability of acceptance of the loan parameters by at least one lending entity, the historical loan application approval data comprising a list of approved/disapproved loan applications, the customer profile for each of the approved/disapproved loan applications, and the financial data for each of the approved/disapproved loan applications.

8. The method of claim 1, further comprising:
training the third machine learning model based on historical loan application approval data to determine the second value indicative of the probability of the customer purchasing the vehicle and the one or more product or service based on the loan parameters, the historical loan application approval data comprising a list of approved/disapproved loan applications, the customer profile for each of the approved/disapproved loan applications, and the financial data for each of the approved/disapproved loan applications.

9. The method of claim 1, wherein determining the third value indicative of the profitability in the purchase of the vehicle and the one or more products or services further based on an original equipment manufacturer (OEM) incentive.

10. A method comprising:
receiving, by a device comprising a processor, a customer identifier associated with a customer interested in a vehicle;
determining, by the device, a financial data associated with the customer identifier and a vehicle data associated with the vehicle;
determining, by the device based on the vehicle data associated with the vehicle, a plurality of recommended vehicles that are similar to the vehicle;
for each recommended vehicle of the plurality of recommended vehicles, determining a deal structure metric by:
determining, by the device, one or more product or a services associated with the recommended vehicle,
determining, by the device using a first machine learning model and based on the financial data associated with the customer identifier and the vehicle data associated with the recommended vehicle, loan parameters for financing purchase of the recommended vehicle and the one or more product or services,
determining, by the device using a second machine learning model, a first value indicative of a probability of acceptance of the loan parameters by at least one lending entity,
determining, by the device using a third machine learning model, a second value indicative of a probability of the customer purchasing the recommended vehicle and the one or more product or services based on the loan parameters, and
determining, by the device using a fourth machine learning model, a third value indicative of a profitability in the purchase of the recommended vehicle and the one or more product or services,
filtering, by the device, at least one recommended vehicle from the plurality of recommended vehicles that based the deal structure metric; and
providing, by the device, a vehicle recommendation to the customer, the vehicle recommendation comprising the vehicle data associated with the at least one recommended vehicle, the one or more product or services associated with the at least one recommended vehicle, and the loan parameters associated with the at least one recommended vehicle.

11. The method of claim 10, wherein filtering the at least one recommended vehicle from the plurality of recommended vehicles based on the deal structure metric comprises filtering the at least one recommended vehicle based on a maximum of a combination of each of the first value, the second value, and the third value.

12. The method of claim 10, wherein determining the loan parameters comprises:
identifying, by the device, one or more estimates associated with a value of the recommended vehicle and the one or more product or services; and
determining, by the device, based on the one or more estimates, the loan parameters.

13. The method of claim 10, wherein determining the loan parameters comprises:
determining, by the device, a buy lending rate; and
determining, by the device, a sale lending rate based on the buy lending rate.

14. The method of claim 13, further comprising:
determining, the profitability as a difference between the sale lending rate and the buy lending rate.

15. The method of claim 3, further comprising:
training the first machine learning model based on historical loan application approval data to predict the buy lending, the historical loan application approval data comprising a list of accepted loan applications, a buy lending rate for each of the accepted loan applications, the customer profile for each of the accepted loan applications, and the financial data for each of the accepted loan applications.

16. The method of claim 13, further comprising:
training the first machine learning model based on historical loan application approval data and the buy lending rate to predict the sale lending rate, the historical loan application approval data comprising a list of accepted loan applications, the buy lending rate for each of the accepted loan applications, and the sale lending rate for each of the accepted loan applications.

17. A system comprising:
a memory storage; and
a processing unit, the processing unit disposed in a station and coupled to the memory storage, wherein the processing unit is operative to:
receive a customer identifier associated with a customer interested in a vehicle;
determine a financial data associated with the customer identifier and a vehicle data associated with the vehicle;
determine, based on the vehicle data associated with the vehicle, a plurality of recommended vehicles that are similar to the vehicle;
for each recommended vehicle of the plurality of recommended vehicles, determine a deal structure metric as:
determine one or more product or a services associated with the recommended vehicle,
determine, using a first machine learning model and based on the financial data associated with the customer identifier and the vehicle data associated with the recommended vehicle, loan parameters for financing purchase of the recommended vehicle and the one or more product or services,
determine, using a second machine learning model, a first value indicative of a probability of acceptance of the loan parameters by at least one lending entity,
determine, using a third machine learning model, a second value indicative of a probability of the customer purchasing the recommended vehicle and the one or more product or services based on the loan parameters, and
determine, using a fourth machine learning model, a third value indicative of a profitability in the purchase of the recommended vehicle and the one or more product or services,
filter at least one recommended vehicle from the plurality of recommended vehicles based the deal structure metric; and
provide a vehicle recommendation to the customer, the vehicle recommendation comprising the vehicle data associated with the at least one recommended vehicle, the one or more product or services associated with the at least one recommended vehicle, and the loan parameters associated with the at least one recommended vehicle.

18. The device of claim 17, wherein the processing device being operative to filter the at least one recommended vehicle from the plurality of recommended vehicles based on the deal structure metric comprises the processing device being operative to filter the at least one recommended vehicle based on a maximum of a combination of each of the first value, the second value, and the third value.

19. The device of claim 17, wherein the processing device being operative to determine the loan parameters comprises the processing device being operative to:
determine, using the first machine learning module, a buy lending rate; and
determine, using the first machine learning module, a sale lending rate based on the buy lending rate.

20. The device of claim 19, wherein the processing device is further operative to:
train the first machine learning module based on a historical loan application approval data to determine the buy lending rate, the historical loan application approval data comprising a list of accepted loan applications, a buy lending rate for each of the accepted loan applications, the loan parameters for each of the accepted loan applications, the vehicle variables for each of the accepted loan applications, and the customer variables for each of the accepted loan applications.
